(19) United States
(12) Patent Application Publication
(10) Pub. No.: US 2024/0401757 A1
(43) Pub. Date: Dec. 5, 2024

(54) Led lamp

(71) Applicant: Green Creative, LTD, Hong Kong (CN)

(72) Inventors: Bertrand Delalande, Shanghai (CN); Ryan Zhang, Shanghai (CN)

(73) Assignee: Green Creative, Hong Kong (CN)

(21) Appl. No.: 18/445,223

(22) Filed: Jun. 5, 2023

(51) Int. Cl. F21K 9/238; F21K 9/233; F21V 17/00; F21V 17/12; F21V 17/16

(52) U.S. Cl. CPC F21K 9/238; F21K 9/233; F21V 17/002; F21V 17/12; F21V 17/16

(57) ABSTRACT

An LED lamp includes interchangeable or replaceable lenses to detachably couple to a housing opening of the LED lamp. The LED lamp also include a safety feature that prevents electrical contact with the high voltage portion of the driver circuit board with a interchangeable or replaceable lens is removed or decoupled from the housing. The safety feature includes an isolated driver circuit and/or a transparent LED shield.

### FIELD OF THE INVENTION

This invention relates to light emitting diode lighting. More particularly, this present invention relates to LED lamps that provide a range of native beam angles.

### BACKGROUND OF THE INVENTION

Parabolic aluminized reflector (PAR) light bulbs have a light engine, a reflector, and pressed lens to provide directional lighting with a native beam angle that is usually under 45 degree. PAR light bulbs have shorter bodies than Bulged Reflector (BR) light bulbs and they are commonly used to provide focused spot-lighting or accent lighting.

Bulged Reflector light bulbs on the other have can have beam angles of 90 degree and greater and are mostly used for flood lighting in places where lots of light is required, such as in stairwells and rooms with high ceilings.

LED PAR light bulbs have a Fresnel lens with a fixed native beam angles and, therefore, different PAR light bulbs need to be used to achieve proper lighting for different spaces.

### SUMMARY OF THE INVENTION

The present invention is directed to a LED lamp. Preferably, the LED lamp is a parabolic aluminized reflector (PAR) lamp with interchangeable or replaceable lenses.

The LED lamp includes a housing with a housing opening, a LED light module and driver circuit board with a high voltage portion and low voltage portion, a reflective insert that surrounds the LED array and circuit board and an interchangeable or replaceable lens. The interchangeable or replaceable lens is configured to couple to the housing opening and enclose the LED array, the driver circuit board and the reflective insert within a cavity formed by the housing and the replaceable lens. The LED lamp also includes a base portion for electrically coupling the LED light modules through the driver circuit board to a power source of a light fixture.

Interchangeable or replaceable lenses provide for a range of different native beam angles. For example, the interchangeable or replaceable lenses can provide for native beam angles between 10 degrees and 40 degrees. A set of interchangeable or replaceable lenses can include a lens that provides a native beam angle of about 10 degrees, a lens that provides a native beam angle of about 25 degrees and a lens that provides a native beam angle of about 40 degrees. The interchangeable or replaceable lenses couple to the housing opening of the LED lamp through a ring feature that can pressure fit or snap onto or around edges of the housing opening of the LED lamp, threaded features on or around edges of interchangeable or replaceable lenses and matched threaded features on or around edges of the housing opening of the LED lamp or any other suitable mechanism that allows the interchangeable or replaceable lenses to detachably couple to the housing opening of the LED lamp.

In accordance with am embodiment of the invention the ring feature can have channel features that twist onto matched tab features on or around edges of the interchangeable or replaceable to form a lens assembly. The lens assembly 219 can then snap or pressure fit onto pressure tab features located on or around edges of the housing opening to detachably couple the lens assembly to the housing.

The invention allows users to selected the native beam angle suitable for a lighting space without replacing the entire LED lamp. Because there is a chance of an electrical shock if a user changes out a lens with a first native beam angle for a different lens with a second native beam angle while the LED lamp is installed and/or powered, the LED lamp of the present invention includes one or more safety features to prevent or reduce the chance of electrical contact when the interchangeable or replaceable lens removed or decoupled from the housing of the LED lamp.

One safety feature includes an isolated LED driver circuit. In accordance with this embodiments the isolated LED driver circuit is configured to energize and power the LED array from a power source and the high voltage portion and low voltage portion are physically separated from each other. For example, the isolated LED driver circuit can have a high voltage portion being below a low voltage portion and, therefore, reducing the chances of contact with the high voltage portion of the LED driver circuit when the interchangeable or replaceable lens is removed or decoupled from the housing of the LED lamp.

In further embodiments of the invention a safety feature includes a transparent LED shield that physically covers the LED array and the LED driver circuit. The transparent shield is made out of clear plastic, poly-carbonate, glass or any similarly transparent material and physically prevents contact with the LED driver circuit when the interchangeable or replaceable lens is removed or decoupled from the housing o of the LED lamp.

### BRIEF DESCRIPTION OF THE DRAWINGS

FIGS. 1A-B show views of a parabolic aluminized reflector (PAR) LED lamp with interchangeable or replaceable lenses that couple and decouple the LED lamp, in accordance with the embodiments of the invention.

FIG. 2 shows an exploded view of a PAR LED lamp with an isolated LED driver circuit configured to energize and power the LED array from a power source wherein the high voltage portion and low voltage portion are physically separated, in accordance with the embodiments of the invention.

FIG. 3 shows an exploded view of a PAR LED lamp with a transparent LED shield that physically covers the LED array and the LED driver circuit, in accordance with the embodiments of the invention.

### DETAILED DESCRIPTION OF THE INVENTION

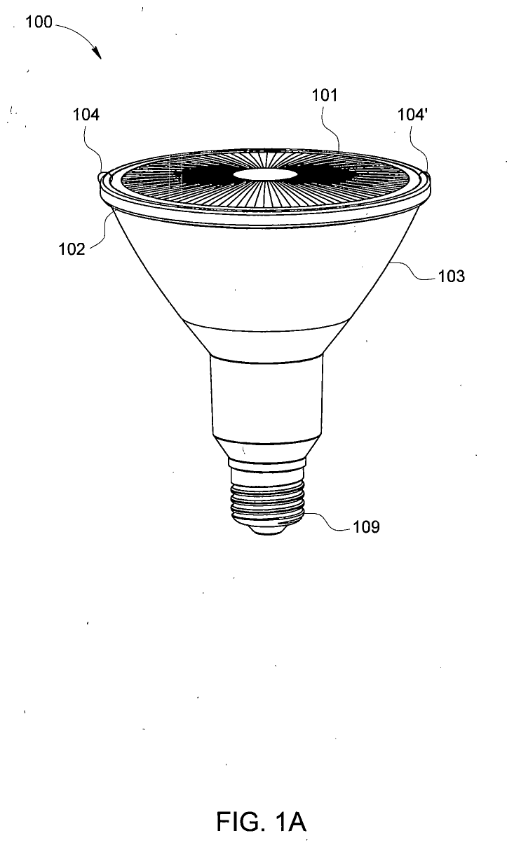

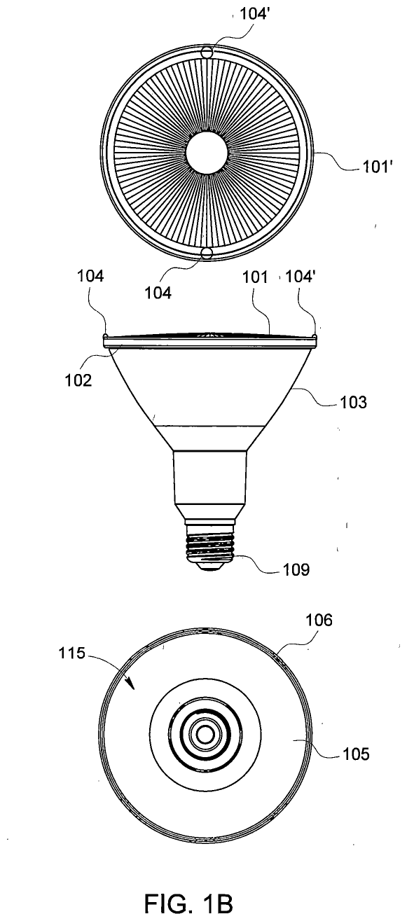

Referring to FIGS. 1A-B present invention is directed to an LED lamp 100. The LED lamp 100 includes a housing 103 that is, for example, cone shaped, and a reflective insert 105. Within the housing 103, there a LED light unit 114 that includes an LED driver, an LED array on a circuit board and all of the necessary wiring and circuitry to power the LED light unit 114 through a base portion 109 when coupled to a power socket of a light fixture. The base portion 109, is shown with threaded screw features, wherein the LED lamp 100 that is configured to replace an incandescent lightbulb. However, it will be clear to one skilled in the art that other base portion configurations are within the scope of the present invention. For example, the base portion 109 can include conductive contact pins, conductive contact pads or any other suitable structure or structures to provide electrical contact with a light fixture socket.

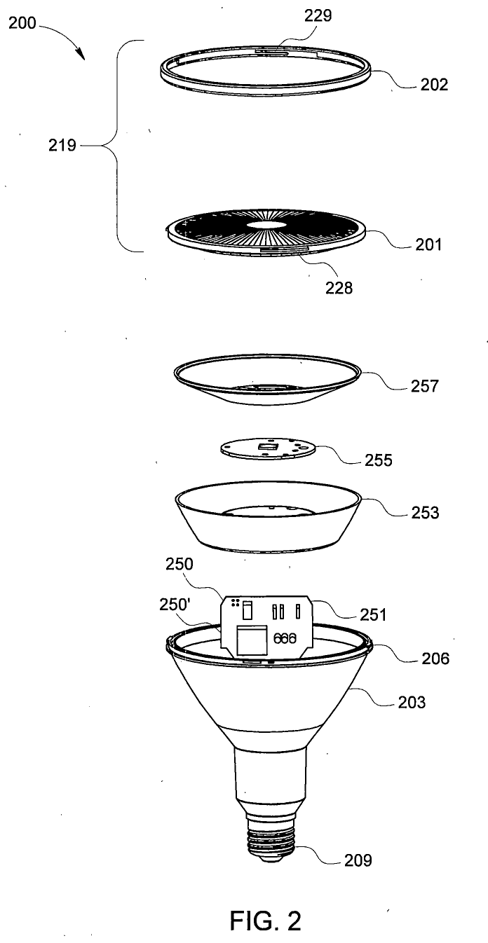

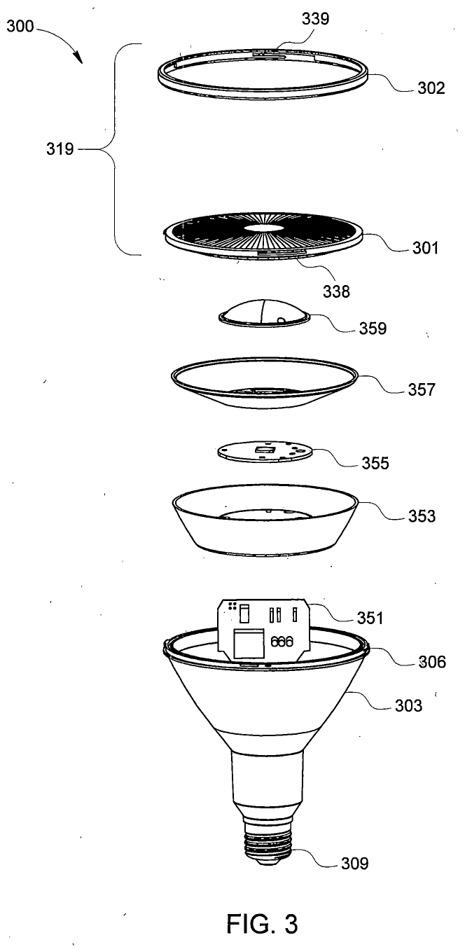

The LED lamp 100 also includes interchangeable or replaceable lens 101 and 101′ to provide for a range of different native beam angles. For example, the interchangeable or replaceable lenses 101 and 101′ can provide for different native beam angles between 10 degrees and 40 degrees. A set of interchangeable or replaceable lenses preferably include lenses that provides native beam angle of about 10 degrees, about 25 degrees and about 40 degrees. The interchangeable or replaceable lenses 101 and 101′ couple to the housing opening 105 of the LED lamp 100 through a snap ring feature 102 that pressure fits on or around edges 106 of the housing opening 115 of the LED lamp 100. Alternatively the interchangeable or replaceable lenses 101 and 101′ couple to the housing opening 115 of the LED lamp 100 through threaded features on or around edges of the interchangeable or replaceable lenses 101 and 101′ and matched threaded features on or around edges 106 of the housing opening 115 of the LED lamp 100 or any other suitable mechanism that allows interchangeable or replaceable lenses 101 and 101′ to be detachably coupled to the housing opening 115 of the LED lamp 100. Where the interchangeable or replaceable lenses 101 and 101′ and 101″ are threaded onto the housing 103, as described above, the interchangeable or replaceable lenses 101 and 101″ can include one or more protruding gripping features, depressions or contoured features 104 and 104′ that provide leverage for a user to twist and tread the interchangeable or replaceable lenses 101 and 101′ on and off of the housing 103 of the LED lamp 100 or on and off of the snap ring feature 102 to make a lens assembly 219 and 319 (FIGS. 2 and 3), such as described below.

FIG. 2 shows an exploded view of a PAR LED lamp 200. The PAR LED lamp 200 includes a lens 201, a reflective insert 257, an LED light engine 255 (LEDs on a Metal Core Printed Circuit Board (MCPCB)), a heat sink 253 and LED driver circuit 251, a housing 203 and a base portion 209. The PAR LED lamp 200 can also include a ring feature 202. The ring feature 202 can have channel features 229 that twist onto matched tab features 228 on or around edges of the replaceable lens 201 to form a lens assembly 219. The lens assembly 219 can then snap or pressure fit onto pressure tab features 206 located on or around edges of the housing opening to detachably couple the lens assembly 219 to the housing 203.

With the PAR LED lamp 200 assembled the reflective insert 257, the LED light engine 255, the heat sink 253 and LED driver circuit 251 are enclosed within the housing 203 by the lens assembly 219 and the LED light engine 255, the LED driver circuit 251 and the base portion 209 are in electrical communication through all necessary connections for the PAR LED lamp 200 to be energized and power the LED light engine 255 through a lamp socket. In accordance with this embodiment of the invention, the LED driver circuit 251 is an isolated LED driver circuit 251.

On the board of the driver circuit 251, a high voltage portion 250′ and a low voltage portion 250 are physically separated with the high voltage portion 250′ being positioned below the low voltage portion 250, thereby, preventing contact of the high voltage portion 250′ when the lens 201 is removed to replaced or changed with a different lens to thereby change the native beam angle emitted by the PAR LED lamp 200, as described above.

FIG. 3 shows an exploded view of a PAR LED lamp 300, in accordance with yet further embodiments of the invention. The PAR LED lamp 300 includes a lens 301, a transparent LED shield 359, a reflective insert 357, an LED light engine 355 (LEDs on a MCPCB), a heat sink 353, a LED driver circuit 351 and a housing 303 and a base portion 309. The PAR LED lamp 300 can also include a ring feature 302. The ring feature 302 can have channel features 339 that twist onto matched tab features 338 on or around edges of the replaceable lens 301 to form a lens assembly 319. The lens assembly 319 can then snap or pressure fit onto pressure tab features 306 located on or around edges of the housing opening to detachably couple the lens assembly 319 to the housing 303.

With the PAR LED lamp 300 assembled, the transparent LED shield 359, the reflective insert 357, the LED light engine 355, the heat sink 353 and the LED driver circuit 351 are enclosed within the housing 303 by the lens assembly 319 and the LED light engine 355, the LED driver circuit 351 and the base portion 309 are in electrical communication through all necessary connections for the PAR LED lamp 300 to be energized and power the LED light engine 355 through a lamp socket.

In accordance with this embodiment of the invention, the LED driver circuit 351 is physical isolated or separated by the transparent LED shield 359 when the lens 301 is removed to replaced or changed the lens 301 with a different lens to thereby change the native beam angle emitted by the PAR LED lamp 300, such as described above. The transparent LED shield 359 can have any suitable shape, but is preferably dome shaped and is formed from any suitable transparent material including, but not limited to, clear plastic, poly-carbonate and glass. The transparent LED shield 359 is attached to the reflective insert 357 through any suitable mechanism including, but not limited to, two-part snap features, pressure tabs and thread features.

The present invention has been described in terms of specific embodiments incorporating details to facilitate the understanding of the principles of construction and operation of the invention. For example, the LED lamp of the present invention can include any number of safety features or combinations of safety features to prevent electrical contact with a user when switching-out interchangeable or replaceable lenses. Also, a replaceable lens, or set of lenses, can be detachably coupled to the LED lamp housing using any suitable means. The replaceable lens, or set of lenses can be Fresnel lenses or any other suitable type of lenses. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

1. A PAR LED lamp comprising:
a) a housing with a housing opening;
b) an LED array and driver circuit board with a high voltage portion and low voltage portion that fits within the housing;
c) a reflective insert that fits within the housing and surrounds the LED array and the driver circuit board;
d) a replaceable lens that is configured to couple to the housing opening and enclose the LED array, the driver circuit board and the reflective insert within a cavity that is formed by the housing and the replaceable lens, wherein the driver circuit board has an isolated LED driver circuit configured to energize and power the LED array from a power source wherein the high voltage portion and low voltage portion are physically separated with the high voltage portion being below the low voltage portion and prevents electrical contact with the high voltage portion of the isolated LED driver circuit with the replaceable lens decoupled from the housing.

2. The PAR LED lamp of claim 1, wherein the replaceable lens is configured to couple to the housing opening through a snap ring feature that pressure fits on or around edges of the opening through pressure tab features.

3. The PAR LED lamp of claim 1, wherein the replaceable lens is configured to couple to the housing opening through threaded features on or around edges of the replaceable lens and matched threaded features on or around edges of the opening.

4. (canceled)

5. The PAR LED lamp of claim 1, further including a transparent LED shield that physically covers the LED array and the LED driver circuit and prevents electrical contact with the driver circuit board with the replaceable lens decoupled from the housing.

6. The PAR LED lamp of claim 1, further comprising a base portion for electrically coupling the LED lamp to a power source of a light fixture.

7. A PAR LED lamp comprising:
a) a housing with a housing opening;
b) an LED array and driver circuit board with a high voltage portion and low voltage portion configured to energize and power the LED array and that fits within the housing;
d) a set of interchangeable lenses that is configured to couple separately to the housing opening and enclose the LED array and the driver circuit board within a cavity formed by the housing and the replaceable lens set of interchangeable lenses, wherein the set of interchangeable lenses include lenses that provide different native beam angles emitted from the LED array when coupled to the housing; and
e) a safety feature that prevents electrical contact with the high voltage portion of the driver circuit board when one of the interchangeable lenses is decoupled from the housing and is being replaced with another of the interchangeable lenses, wherein the safety feature includes an transparent LED shield that physically covers the LED array and the LED driver circuit.

8. The PAR LED lamp of claim 7, wherein the different native beam angles include different native beam angles between 10 degrees and 40 degrees.

9. The PAR LED lamp of claim 7, wherein interchangeable lenses are configured to couple to the housing opening through threaded features on or around edges of the interchangeable lenses and matched threaded features on or around edges of the opening, wherein the interchangeable lenses each have protruding gripping features.

10. The PAR LED lamp of claim 7, wherein the high voltage portion and low voltage portion of the driver circuit board are physically separated with the high voltage portion being below the low voltage portion.

11. (canceled)

12. The PAR LED lamp of claim 7, further comprising a base portion for electrically coupling the LED lamp to a power source of a light fixture.

13. A PAR LED lamp comprising:
a) a housing with a housing opening;
b) an LED array and driver circuit board with a high voltage portion and low voltage portion that fits within the housing;
c) a reflective insert that fits within the housing and surrounds the LED array and the driver circuit board;
d) a replaceable lens that is configured to couple to the housing opening and enclose the LED array, the driver circuit board and the reflective insert within a cavity formed by the housing and the replaceable lens; and
e) a safety feature that includes transparent dome-shaped LED shield that physically covers the LED array and the LED driver circuit preventing physical contact with the LED array and the LED driver circuit when the replaceable lens is decoupled from the housing.

14. The PAR LED lamp of claim 13, wherein the replaceable lens is configured to couple to the housing opening through a ring feature with channel features that twist on to matched tab features on or around edges the replaceable lens to form a lens assembly.

15. The PAR LED lamp of claim 14, wherein the lens assembly snaps onto pressure tab features on or around edges of the housing opening to detachably couple the lens assembly to the housing.

16. The PAR LED lamp of claim 13, the replaceable lens has a native beam angle between 10 degrees and 40 degrees.
